(19) United States
(12) Patent Application Publication
(10) Pub. No.: US 2026/0273773 A1
(43) Pub. Date: Sep. 17, 2026

(54) HAND-LOCAL PREDICTIVE TACTILE ACTUATION GATE FOR ARTIFICIAL INTELLIGENCE (AI) CONTROLLED DEXTEROUS ROBOTIC MANIPULATION

(71) Applicant: Dorian Catwright, San Jose, CA (US)

(72) Inventor: Dorian Catwright, San Jose, CA (US)

(21) Appl. No.: 19/686,121

(22) Filed: May 22, 2026

Related U.S. Application Data
(63) Continuation-in-part of application No. 19/638,074, filed on Apr. 2, 2026.

(51) Int. Cl. B25J 15/00; B25J 9/16; B25J 13/08

(52) U.S. Cl. CPC B25J 15/0009; B25J 9/161; B25J 9/1674; B25J 13/084

(57) ABSTRACT

A robotic hand module includes a host-attachment interface, hand command interface, articulated digits, tactile sensors, finger actuators, finger-actuator interface, and hand local predictive tactile validator. A candidate grasp command from an upstream control system is intercepted before corresponding finger actuation. The validator predicts a tactile consequence based on tactile context, object information, actuator state, calibration data, wear state data, or contact history. A grip release controller compares the predicted tactile consequence with a grip-safety policy and selectively releases, modifies, delays, decomposes, or blocks the command before execution. The module may operate in a centralized humanoid robot or as a vendor-agnostic component, with validation performed locally, at a robot brain or fleet level, or at a remote data center.

### CROSS-REFERENCE TO RELATED APPLICATION (S)

This application is a continuation-in-part of U.S. patent application Ser. No. 19/638,074, filed Apr. 2, 2026, and entitled PREDICTIVE ACTUATION GATING IN PHYSICAL ARTIFICIAL INTELLIGENCE; claims priority under 35 U.S.C. § 119(e) to U.S. Provisional Patent Application No. 64/070,361, filed May 20, 2026, by Dorian Cartwright and entitled HARDWARE-ENFORCED VALIDATED ACTUATION FOR AUTONOMOUS PHYSICAL ARTIFICIAL INTELLIGENCE (AI) SYSTEMS; claims priority under 35 U.S.C. § 119(e) to U.S. Provisional Patent Application No. 64/070,365, filed May 20, 2026, and entitled PROTECTED PHYSICAL ARTIFICIAL INTELLIGENCE (AI) ACTUATOR FIREWALL OPERATING SYSTEM; and is related to U.S. patent application Ser. No. 19/654,785, filed Apr. 22, 2026, and entitled DECENTRALIZED STORAGE-SLOT RESERVATION IN A HETEROGENEOUS PHYSICAL ARTIFICIAL INTELLIGENCE SWARM, U.S. patent application Ser. No. 19/654,952, filed Apr. 22, 2026, and entitled DECENTRALIZED ENCOUNTER-BASED SHARING OF SEMANTIC HAZARD DATA IN A HETEROGENEOUS PHYSICAL ARTIFICIAL INTELLIGENCE SWARM, and U.S. patent application Ser. No. 19/654,808, filed Apr. 22, 2026, and entitled DECENTRALIZED LOAD-SHARING AND POSITIONAL COORDINATION IN A HETEROGENEOUS PHYSICAL ARTIFICIAL INTELLIGENCE SWARM, the entire contents of each being hereby incorporated by reference in their entirety.

### FIELD OF THE INVENTION

The present disclosure relates generally to computers and artificial intelligence, and more specifically, to validation layers of a hand that predict tactile consequences of candidate grasp commands before finger actuation.

### BACKGROUND

Humanoid robots and other physical artificial intelligence platforms increasingly rely on dexterous robotic hands to interact with objects, tools, humans, packages, workpieces, fixtures, and unstructured environments. A high-level planner, vision-language-action model, reinforcement learning controller, teleoperation system, robot operating system, or other decision module may generate a grasp command or manipulation command for execution by a robotic hand.

Dexterous manipulation presents technical challenges that are not fully addressed by whole-robot planning alone. A candidate grasp may appear acceptable at a visual, semantic, or macro-motion level but may produce an unsafe or failed physical outcome when executed locally by finger actuators. For example, the grasp may cause incipient slip, excessive contact force concentration, object deformation, fracture of a fragile object, unstable tool alignment, tendon overload, actuator saturation, finger-linkage collision, collision with a bounded region, or loss of grasp stability.

Conventional robotic hands often use tactile sensors, force sensors, slip detectors, impedance controllers, or force-control loops to adjust finger motion. However, many such systems treat tactile data as feedback inside a monolithic controller after motion has already begun. Other systems rely on whole-robot safety controllers that evaluate macro-scale motion, collision avoidance, balance, path planning, or workspace constraints. Such systems may not adequately validate localized contact mechanics occurring within a hand, wrist, or forearm-hand module before finger actuator release.

A further problem arises as humanoid hands become modular components supplied separately from the rest of a robot. A specialist hand manufacturer may supply a dexterous hand to multiple humanoid robot manufacturers or robotic platform vendors. Such a hand may receive high-level grasp commands from different host robots, operating systems, planners, fleet controllers, or learning models. If the host system can directly command finger actuators, the hand may execute unsafe or poorly calibrated grasp motions. Component-specific conditions, such as tactile sensor drift, tendon stretch, cable slack, joint backlash, elastomeric skin wear, local actuator temperature, firmware trust state, or hand-specific calibration error, may not be known to the host planner.

There is also a technical distinction between centralized humanoid manufacturing architectures and decentralized vendor-agnostic component architectures. In a centralized humanoid architecture, a full robot manufacturer may design the robot brain, robot operating system, robot-level predictive validation layer, hand controller, and actuator subsystem as an integrated stack. In a decentralized architecture, a hand manufacturer may sell a modular hand that includes local compute, local tactile sensing, local validation, actuator enforcement, calibration memory, and a host-agnostic command interface. Such a modular hand may need to validate candidate grasp commands locally without trusting, or depending on, any particular host robot architecture.

In addition, validation of physical AI action may occur at different layers. A robot-level predictive actuation gate may evaluate macro-level candidate actions, such as reaching, walking, balancing, navigating, load sharing, or arm motion. An operating system-level or middleware-level actuator firewall may intercept actuator-directed calls, normalize candidate-action objects, select validators, and issue release authorizations. A hand-local tactile gate may perform low-level tactile validation focused on finger actuation, contact mechanics, tool alignment, object deformation, and grip stability. These validation layers are complementary rather than duplicative because they operate at different abstraction levels, use different models, and enforce different execution envelopes.

There is a need for a robust robotic hand module that can operate as part of a full humanoid robot and also as a vendor-agnostic component. There is a need for hand-local predictive tactile validation that receives candidate grasp commands from an upstream control system, predicts tactile consequences before finger actuation, and selectively releases, modifies, delays, decomposes, or blocks the candidate grasp command. There is also a need for the hand-local validator to cooperate with robot-level predictive validation, operating system-level actuator firewall validation, hardware enforced actuator authorization, and multi-tier AI inference architectures.

### SUMMARY

The present disclosure addresses these shortcomings with systems, methods, and computer program products for hand-local predictive tactile actuation gating in artificial intelligence-controlled dexterous robotic manipulation.

A robotic hand module includes a host-attachment interface, a hand command interface, articulated digits, tactile sensors, finger actuators, a finger-actuator interface, and a hand-local predictive tactile validator. The robotic hand module may be configured as a vendor-agnostic component attachable to different host robots, including humanoid robots, mobile manipulators, industrial arms, teleoperated robots, service robots, warehouse robots, and other physical AI platforms. The robotic hand module may also be integrated into a full humanoid robot manufactured by a single robot manufacturer.

A candidate grasp command is received from an upstream control system. The upstream control system may comprise a host robot controller, whole body action generator, robot brain, fleet controller, robot operating system, actuator firewall, VLA model, reinforcement-learning policy, grasp planner, teleoperation system, or remote data center inference service. Before corresponding finger actuation is released, the hand-local predictive tactile validator generates a predicted tactile consequence of executing the candidate grasp command.

The predicted tactile consequence may include incipient slip, micro-slip transition, contact force concentration, object deformation, object fracture likelihood, unstable contact transition, insertion failure, tool use instability, tendon overload, actuator saturation, finger linkage collision, wrist torque overload, resonant tool behavior, human contact risk, or loss of grasp stability. The prediction may use tactile sensor data, force-torque data, contact history, object descriptors, surface descriptors, hand calibration data, tendon stretch data, joint-backlash data, wear state data, temperature data, environmental hazard data, shared object-state data, or downstream execution telemetry.

A grip release controller compares the predicted tactile consequence with a grip safety policy. Based on the comparison, the grip release controller selectively releases, modifies, delays, decomposes, or blocks the candidate grasp command before the finger actuator interface transmits corresponding actuator commands to the plurality of finger actuators.

In some embodiments, the grip release controller issues a time bounded actuation authorization token or release authorization associated with a validated finger-actuator command. A motor driver, actuator controller, tendon motor controller, servo controller, H-bridge controller, brake controller, or embedded actuator firmware may maintain a corresponding actuator endpoint in a non-executable state unless the release authorization is verified, and may enable execution only within a validator-derived grip envelope. The grip envelope may identify one or more authorized fingers, joints, actuators, forces, torques, current limits, velocity limits, position ranges, stiffness values, contact-force limits, time windows, or revocation conditions.

The disclosed hand-local validator may operate with multiple complementary validation layers. A robot-level predictive validation layer may evaluate whole-body candidate actions using macro-level models, including world models, balance models, collision predictors, load-sharing models, or robot-level tactile predictors. An operating system-level or middleware-level tactile validation layer may intercept actuator-directed requests, normalize candidate-action objects, select validators, and issue release authorizations. The hand-local validation layer may then perform component-level tactile prediction and finger-actuator authorization. These layers may cooperate through validation status, execution envelopes, actuator syscalls, release tokens, policy state, telemetry, and model updates.

The disclosed system may use AI inference at different tiers. A local hand inference layer may execute on a microcontroller, embedded processor, NPU, FPGA, ASIC, or secure enclave within the hand, wrist, carpal chassis, or forearm-hand module. A robot-level or brain-level inference layer may execute on a host robot processor or fleet-level edge controller. A remote data enter inference layer may provide larger model reasoning, simulation, fleet learning, policy updates, or model retraining. The hand-local validator may operate independently if remote or robot-level inference is unavailable, thereby supporting decentralized and vendor-agnostic operation.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating a hand module of a humanoid robot to predictively validate commands, according to an embodiment.

FIG. 2 is a sequence diagram illustrating hand-local predictive tactile validator inputs and outputs, according to an embodiment.

FIG. 3 is a block diagram illustrating validation layers for candidate command actions from VLA action generation to actuator action, according to an embodiment.

FIG. 4 is a block diagram illustrating a vendor-agnostic modular robotic hand assembly attachable to different host robots, according to an embodiment.

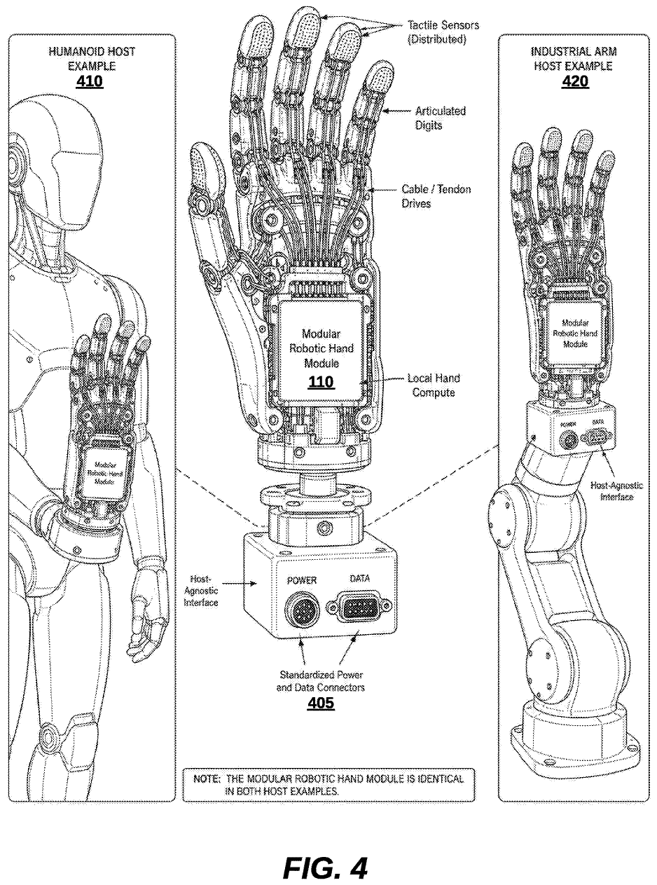

FIG. 5 is a block diagram illustrating a computer environment suitable for implementing components of the system, according to an embodiment.

FIG. 6 is a flow chart illustrating a method for hand-local predictive tactile validation of a candidate grasp command before finger actuator release, according to an embodiment.

FIG. 7 is a flow chart illustrating a method for layered validation using robot-level validation, operating system-level tactile validation, and hand-local tactile validation, according to an embodiment.

FIG. 8 is a flow chart illustrating a method for issuing, enforcing, renewing, and revoking finger-actuator release authorizations, according to an embodiment.

### DETAILED DESCRIPTION

The following description provides systems, methods, and computer program products for hand-local predictive tactile actuation gating in dexterous robotic manipulation. The described embodiments are illustrative and not limiting. Features described with respect to one embodiment may be combined with features of other embodiments unless context indicates otherwise.

### I. SYSTEMS FOR HAND-LOCAL PREDICTIVE VALIDATION

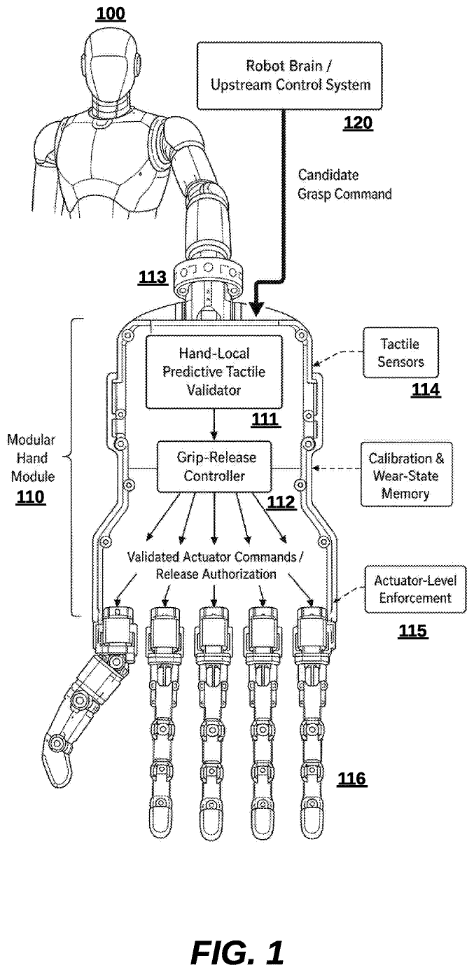

Referring to FIG. 1, a block diagram illustrates a centralized humanoid robot architecture. A humanoid robot 100 includes a torso, one or more arms, one or more robotic hands, a robot brain, a robot operating system, one or more perception modules, one or more action-generation modules, one or more validation layers, and one or more actuator subsystems. The robot brain may include processors, accelerators, memory, and software configured to perform perception, planning, reasoning, localization, balance control, task planning, manipulation planning, natural-language interaction, and physical actuation control.

In the centralized humanoid architecture, a full humanoid manufacturer may design and integrate the robot brain, robot operating system, arms, hands, tactile sensors, actuator controllers, and validation layers. A high-level action generator may generate candidate actions for the entire humanoid robot. Such actions may include locomotion, reaching, arm positioning, object approach, grasping, lifting, tool use, handover, storage placement, cooperative load handling, or human interaction. A robot-level predictive validator may evaluate such candidate actions before physical execution.

A robot-level predictive validator may operate at a macro level. For example, the robot-level predictive validator may evaluate whether a reaching action would cause loss of balance, collision with a nearby object, excessive arm torque, unsafe proximity to a human, interference with a peer robot, violation of a bounded region, or conflict with a shared-load task. The robot-level predictive validator may use world models, digital twins, collision predictors, balance models, reachability models, whole-body dynamics models, load-sharing models, semantic hazard models, or tactile-predictive models operating at a robot-wide abstraction level.

A hand-local predictive tactile validator 111 operates at a different level. Rather than evaluating the whole-body macro action, the hand-local validator evaluates localized contact mechanics of the robotic hand. For example, the robot-level validator may approve the high-level act of reaching toward an apple. The hand-local validator may then determine whether a proposed finger closure will bruise, fracture, slip on, or drop the apple. In this manner, the robot-level validator and hand-local validator are complementary rather than redundant.

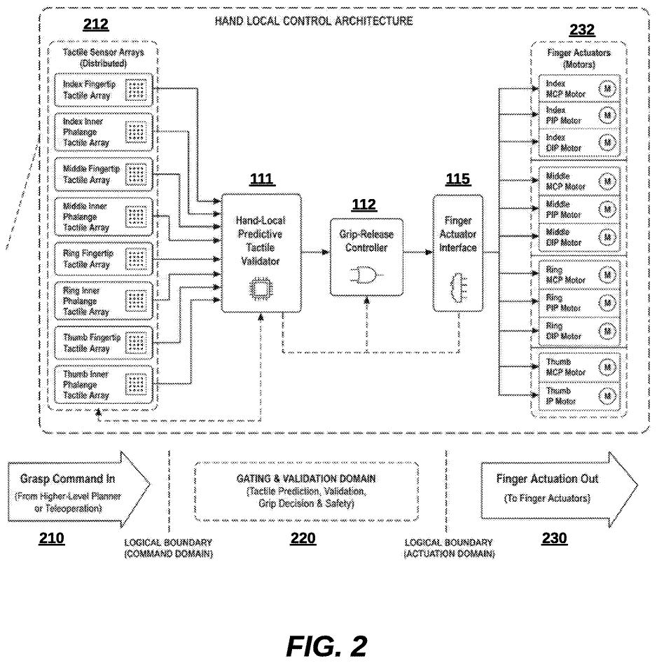

The robotic hand module 110 can be configured for attachment to different host robots through one or more mechanical, electrical, communication, power, timing, safety, or software interfaces, in an embodiment. The host robot may comprise a humanoid robot, mobile manipulator, industrial robot arm, teleoperated robot, service robot, warehouse robot, medical robot, construction robot, agricultural robot, or other physical AI platform. The hand module 110 includes the hand-local predictive tactile validator 111, a grip-release controller 112, a wrist connect 113, tactile sensors 114, actuator-level enforcement 115 of robot fingers 116. Candidate grasp commands are received by the robotic hand module 110 from an upstream control system (e.g., VLA command generator). FIG. 2 shows a sequence of a grasp command 210, gating and validation layers 220 and finger actuation out 230. The grasp command may be initiated based on feedback from a tactile sensor array 212 corresponding to individual fingers and cause finger actuators 232 to activate.

In some embodiments, the robotic hand module 110 is manufactured, sold, licensed, tested, calibrated, certified, replaced, or upgraded as a component separate from the host robot. The robotic hand module may include its own local processor, tactile sensors, finger actuators, actuator drivers, hand-local predictive tactile validator, grip release controller, local inference engine, calibration memory, wear state memory, actuator authorization logic, and command interface. The hand module may validate candidate grasp commands independently of whether the host robot includes a compatible robot-level validator.

The modular robotic hand assembly may include a host-attachment interface. The host attachment interface may comprise a mechanical mount, wrist coupling, quick-release interface, power interface, data interface, fieldbus interface, safety channel, clock synchronization interface, calibration interface, authentication interface, or combinations thereof. The module may expose a host-agnostic command interface configured to receive candidate grasp commands from different host robot control architectures.

In some embodiments, the modular hand assembly includes a compatibility layer. The compatibility layer may translate host-specific grasp commands into a common hand command representation. For example, candidate commands from a robot operating system, ROS-based controller, proprietary humanoid controller, remote inference service, teleoperation station, fleet controller, or actuator firewall may be converted into a candidate grasp command consumable by the hand-local predictive tactile validator.

The decentralized nature of the robotic hand module can improve safety and portability. Because validation occurs locally at the hand, a specialist hand manufacturer can provide a trusted dexterous manipulation component that polices physical side effects even when attached to a host robot manufactured by a different party. The hand may refuse unsafe or unauthenticated commands regardless of whether those commands originate from a host robot brain, a remote data center, a teleoperator, or a compromised software process.

### B. Layered Tactile Validation and AI Inference Architecture

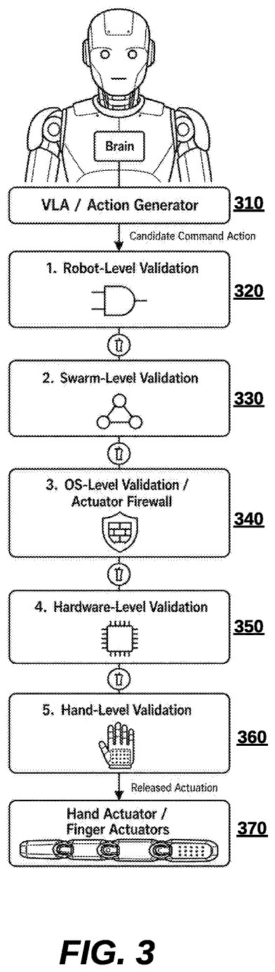

FIG. 3 illustrates complementary validation layers. A first validation layer may comprise a robot-level predictive actuation validator. A second validation layer may comprise an operating system-level or middleware-level actuator firewall. A third validation layer may comprise a hand-local predictive tactile validator. Additional validation layers may be used, including actuator-level hardware enforcement, fleet-level policy validation, remote simulation validation, or human-supervisory validation.

The robot-level predictive actuation validator may evaluate candidate actions at a whole-robot level. It may receive candidate actions generated by a VLA model, large language model, planning model, reinforcement-learning policy, behavior tree, symbolic planner, motion planner, teleoperation system, or hybrid controller. It may evaluate macro-scale physical consequences using AI models or deterministic models. Example models include whole-body dynamics models, balance predictors, collision predictors, semantic hazard models, digital twins, spatial occupancy models, load-sharing models, reachability models, trajectory-risk models, and learned action validators.

The operating system-level or middleware-level actuator firewall may operate between action generation and actuator subsystems. It may intercept actuator-directed requests, actuator syscalls, robot operating system calls, controller API calls, message-bus commands, middleware requests, or candidate action requests before physical execution. It may normalize intercepted requests into candidate-action objects, obtain contextual state, select one or more validators, evaluate validator outputs against actuation policies, and issue release authorizations defining validator-derived execution envelopes. The contextual state may include human proximity, semantic hazards, shared occupancy, peer robot state, shared load state, environment state, tool state, object state, or combinations thereof.

The operating system-level tactile validation layer may provide a mid-level abstraction. For example, it may determine that a grasp-related actuator syscall should be routed to the hand-local tactile validator. It may also apply policy constraints such as human-proximity conditions, object fragility metadata, enterprise safety policy, or workflow-stage constraints. The operating system-level layer may not need to model detailed finger-pad shear forces or tendon slack; those details may be handled by the hand-local validator.

The hand-local predictive tactile validator may operate at a low-level component boundary. It may use tactile sensor data, contact history, hand-specific calibration, actuator state, tendon stretch, joint backlash, sensor drift, local object estimates, and a tactile physics or learned model to predict tactile consequences before finger actuator release. The hand-local validator may output a release decision, modified command, staged subcommand sequence, fallback command, or finger-level authorization token.

The actuator-level hardware enforcement layer may maintain actuator endpoints in a locked, disabled, braked, unpowered, reduced-authority, power-gated, or non-executable state unless a release authorization is verified. Upon verification, the actuator controller may enable physical execution only within a validator-derived execution envelope. The actuator controller may prevent, limit, revoke, or terminate physical execution when authorization is absent, invalid, expired, inconsistent with current conditions, or violated by actuator telemetry.

The layers may communicate using validation status data, release authorization data, candidate-action objects, grip envelopes, actuator identifiers, tactile prediction results, context hashes, policy versions, telemetry, fault indicators, revocation signals, or audit records. In some embodiments, a higher-level layer delegates tactile validation to a lower-level hand module. In other embodiments, a lower-level hand module rejects a command that was approved at a higher level because localized tactile conditions changed.

Inference can also be performed in tiers. A local hand inference layer executes within or near the robotic hand module. The local hand inference layer may run on a microcontroller, embedded CPU, DSP, NPU, FPGA, ASIC, secure enclave, or other local processing circuit. It may execute a small tactile prediction model, control barrier model, friction model, learned slip predictor, object compliance model, hand kinematics model, tendon model, actuator model, or hybrid tactile validator.

A robot-level or brain-level inference layer may execute on a host robot processor. The robot-level inference layer may execute larger models than the local hand layer, including VLA models, LLMs, multimodal models, world models, action planners, whole-body motion validators, balance validators, and task reasoning models. The robot-level inference layer may coordinate multiple subsystems including locomotion, arms, hands, head, sensors, batteries, and communications.

A fleet-level inference layer may execute on an edge server, local facility server, warehouse server, factory controller, or peer robot. It may aggregate knowledge across multiple robots and produce policies, hazard information, shared object states, load-sharing allocations, storage reservations, or skill updates. In some embodiments, another robot with greater compute capacity performs inference for a lower-power robot or for a vendor-agnostic hand module.

A remote data center inference layer may execute high-capacity models, simulation workloads, policy training, large-scale tactile model training, digital-twin rollouts, or fleet analytics. The remote data enter layer may provide updated tactile models, grip policies, object models, calibration adjustments, or software updates to hand modules or host robots. The local hand inference layer may continue operating even when the remote data enter layer is unavailable, delayed, or untrusted.

The multi-tier architecture allows validation to be allocated according to latency, privacy, compute, safety, and connectivity needs. Finger-actuator release may require low latency and may therefore be validated locally. Whole-body plan validation may be performed by the robot brain. Fleet-level semantic hazard updates may be produced by edge infrastructure. Remote data centers may periodically improve models but need not participate in every grasp.

### C. Robotic Hand Module and Actuator Enforcement

The hand module 110 may comprise a standalone hand, wrist-hand assembly, carpal-hand assembly, forearm-hand assembly, gripper with articulated digits, or other dexterous end-effector. The module includes a hand command interface, a hand-local predictive tactile validator, a grip release controller, a finger-actuator interface, tactile sensors, articulated digits, and finger actuators.

In some embodiments, arm, wrist, and hand control are separated into nested control structures. An arm controller may manage gross positioning of a shoulder, elbow, arm linkage, arm trajectory, reach envelope, end-effector approach path, collision avoidance, or placement of the robotic hand assembly relative to an object. A wrist controller may manage wrist pitch, yaw, roll, torque compliance, rotational alignment, insertion angle, tool orientation, or force-torque coupling between the arm and the hand. A hand controller may manage local dexterous execution, including finger joints, tendon motors, fingertip forces, palm contact, active palm motion, tactile sensing, grip sequencing, contact point selection, grip force, and local release authorization before finger actuation.

In some embodiments, a candidate manipulation action is decomposed into an arm portion, a wrist portion, and a hand portion by a robot brain, whole-body controller, robot operating system, actuator firewall, grasp planner, or other upstream control system. The arm portion may be routed to the arm controller, the wrist portion may be routed to the wrist controller, and the hand portion may be routed to the hand command interface of the robotic hand assembly. The hand-local predictive tactile validator may validate the hand portion before corresponding finger actuation, palm actuation, or wrist-hand actuation is released.

In other embodiments, the hand controller receives a higher-level grasp command directly from a robot operating system, actuator firewall, vision-language-action model, grasp planner, teleoperation controller, or robot brain and coordinates with the arm controller or wrist controller. For example, when the hand-local predictive tactile validator predicts slip, excessive force concentration, tool misalignment, insertion jamming, object deformation, or wrist torque overload, the hand controller may request a wrist rotation, wrist compliance change, wrist torque limit, arm repositioning, or modified approach trajectory.

The articulated digits may include fingers, thumbs, opposing digits, underactuated digits, tendon-driven digits, linkage-driven digits, soft digits, compliant digits, rigid digits, palm elements, active palm portions, or combinations thereof. The finger actuators may include electric motors, tendon motors, servo motors, linear actuators, pneumatic actuators, hydraulic actuators, shape-memory actuators, electrostatic actuators, piezoelectric actuators, variable-stiffness actuators, brakes, clutches, or other actuation devices.

The tactile sensors may include pressure sensors, force sensors, shear sensors, capacitive tactile sensors, piezoresistive tactile sensors, optical tactile sensors, vision-based tactile sensors, elastomeric skin sensors, strain gauges, vibration sensors, temperature sensors, proximity sensors, force-torque sensors, joint torque sensors, tendon tension sensors, or combinations thereof. The tactile sensors may be disposed on fingertips, finger pads, finger sides, knuckles, palm regions, wrist regions, active palm regions, tool-contact regions, or other contact surfaces.

The hand-local predictive tactile validator may be implemented in a processor, microcontroller, digital signal processor, neural processing unit, field-programmable gate array, application-specific integrated circuit, secure enclave, embedded controller, firmware module, software module, or distributed set of processors. The validator may be located within the palm, wrist, carpal chassis, forearm housing, a finger module, or a nearby hand controller. Different fingers may include local validators that cooperate with a palm-level validator.

The hand command interface receives candidate grasp commands from an upstream control system. The upstream control system may comprise a host robot controller, whole-body action generator, robot brain, robot operating system, actuator firewall, VLA model, large language model, small language model, motion planner, grasp planner, teleoperation device, cloud service, fleet controller, or peer robot.

The finger-actuator interface transmits actuator commands to finger actuators or motor drivers. The hand-local predictive tactile validator is positioned logically between the hand command interface and the finger-actuator interface. In some embodiments, the upstream controller cannot directly command the finger-actuator interface. The robotic hand module may enforce a command path in which unvalidated commands are blocked from reaching low-level motor drivers.

The candidate grasp command may be represented at various abstraction levels. In one embodiment, the command is a named grasp, such as pinch, power grasp, tripod grasp, precision grip, tool grip, insertion grip, or handover grip. In another embodiment, the command includes finger trajectories or joint targets. In another embodiment, the command includes low-level torque, velocity, current, stiffness, or tendon-tension commands. The hand-local validator may operate across one or more of these command levels.

The hand-local predictive tactile validator generates a predicted tactile consequence of executing a candidate grasp command before corresponding finger actuation is released. The prediction may be generated using a local tactile physics model, learned dynamics model, neural network, physics-informed neural network, digital twin, control barrier model, friction-cone model, object compliance model, hand kinematics model, tendon model, actuator model, or hybrid model.

The validator may receive tactile context including tactile sensor data, contact history, force-torque data, object descriptor data, surface descriptor data, hand pose, wrist pose, palm pose, actuator state, tendon stretch, cable slack, joint backlash, skin wear, sensor drift, calibration data, temperature data, humidity data, environmental hazard data, or prior outcome data.

The predicted tactile consequence may include incipient slip, micro-slip transition, loss of force closure, excessive contact-force concentration, excessive shear force, object deformation, object fracture likelihood, unstable contact transition, local crushing risk, surface damage risk, unstable tool alignment, insertion failure, jamming risk, finger-linkage collision, wrist torque overload, tendon overload, actuator saturation, loss of object retention, excessive vibration, resonant tool behavior, human-contact risk, or insufficient confidence in tactile state.

The grip release controller compares the predicted tactile consequence with a grip-safety policy. The grip-safety policy may include object-specific, task-specific, user-specific, site-specific, host-robot-specific, hand-specific, or fleet-specific constraints. The policy may define acceptable force ranges, pressure distributions, shear-force limits, slip margins, deformation limits, fracture-risk thresholds, allowed contact points, allowed finger configurations, actuator current limits, torque limits, velocity limits, stiffness limits, timing constraints, or fallback requirements.

Based on the comparison, the grip release controller selectively releases, modifies, delays, decomposes, or blocks the candidate grasp command. Releasing may include transmitting an actuator command corresponding to the candidate grasp command to the finger actuator interface. Modifying may include changing grip force, changing finger trajectory, changing a contact point, changing finger stiffness, reducing velocity, reducing actuator current, altering wrist pose, changing an active palm motion, or selecting a different grasp. Delaying may include waiting for additional tactile sensor data, waiting for a bounded region to become available, waiting for another robot to stabilize a shared object, or waiting for a human to move away. Decomposing may include splitting a grasp into staged subcommands, each separately validated. Blocking may include rejecting a command and optionally notifying an upstream controller.

The grip release controller may issue one or more release authorizations for validated commands. A release authorization may be time-bounded, actuator-specific, finger-specific, joint-specific, trajectory-specific, object-specific, or envelope-specific. The release authorization may identify an authorized actuator, command class, time window, grip force, joint-position range, actuator-current range, velocity range, stiffness range, trajectory segment, object class, safety mode, or expiration condition.

A finger actuator, motor driver, tendon motor, servo controller, H-bridge controller, brake controller, or embedded actuator firmware may parse the release authorization and reject actuator commands that lack a valid authorization or exceed a validator-derived grip envelope. The release authorization may be cryptographically signed, hashed, keyed, authenticated, or otherwise protected from unauthorized modification.

In some embodiments, the release authorization includes a motion budget, force budget, torque budget, energy budget, or time budget. The actuator controller may track cumulative execution and refuse further movement when the budget is consumed. In some embodiments, token revocation causes the actuator to enter a fail-passive mode, isometric hold, brake-locked state, low force retention state, or other fallback grasp-maintenance state rather than simply dropping power.

In some embodiments, hand validation is affected by interactions with nearby robots. The hand-local validator may receive optional external context from other robots or swarm systems. Such information may include semantic hazard data, shared object-state data, cooperative load-role data, bounded-region reservation data, route constraints, surface condition data, object fragility warnings, manipulation history, fleet-level object-handling statistics, or peer robot tactile outcomes.

For example, semantic hazard data may indicate that an object or surface is slippery, hot, dusty, abrasive, wet, chemically contaminated, fragile, unstable, or recently dropped. The hand-local validator may use the data to modify friction assumptions, contact force limits, or required confidence thresholds. Cooperative load-role data may indicate that the robot is responsible for a particular portion of a shared load handled by multiple robots in cooperation. The hand-local validator may convert the assigned load role into finger specific grip force limits or wrist torque envelopes. Bounded-region reservation data may identify a narrow bin, shelf, handoff zone, workcell, or storage cavity. The validator may reject a grasp command that would cause finger sprawl or object motion outside a reserved region.

FIG. 9 illustrates a hand-specific calibration and wear state profile. The robotic hand module may maintain a hand-specific calibration profile or wear state passport stored in nonvolatile memory. The profile may be associated with a serial number, component identifier, cryptographic identifier, firmware version, or calibration certificate.

The profile may include tactile sensor offsets, sensor drift values, sensor confidence values, tendon stretch, cable slack, joint backlash, actuator response curves, motor friction, gear wear, elastomeric skin wear, maximum force envelope, thermal characteristics, cumulative duty cycles, repair history, component replacement history, firmware trust level, or authorized host-robot compatibility.

The hand-local predictive tactile validator may use the profile to adjust predicted tactile consequences. For example, a worn tactile skin may reduce confidence in pressure readings. Tendon stretch may cause delayed or reduced finger motion. Backlash may increase predicted slip risk during precision grasps. The grip-safety policy may be tightened as the hand ages or as calibration confidence decreases.

### D. Training and Deployment of Hand-Local Tactile Prediction Models

In some embodiments, the hand-local predictive tactile validator executes a tactile prediction model stored in nonvolatile memory of the robotic hand module. The tactile prediction model may be trained before deployment using controlled grasp trials, simulated grasp trials, digital-twin contact simulations, object-material datasets, tactile sensor calibration data, actuator telemetry, tendon-load data, and labeled or self-supervised downstream outcomes. The tactile prediction model may be compressed, quantized, distilled, pruned, or otherwise optimized for execution on a local processor, microcontroller, neural processing unit, FPGA, ASIC, secure enclave, or embedded controller of the robotic hand module.

In some embodiments, a larger robot-level model, fleet-level model, or remote data enter model trains or refines a baseline tactile prediction model, while the robotic hand module executes a smaller local version of the model for low-latency grasp validation. The local version may comprise a distilled student model, lookup-enhanced neural model, hybrid physics-neural model, control-barrier model, friction model, learned slip predictor, object compliance model, hand kinematics model, tendon model, actuator model, or ensemble of such models.

In some embodiments, the hand-local predictive tactile validator updates the tactile prediction model based on downstream outcomes sensed after execution of a released or modified command. The downstream outcomes may include actual tactile responses, slip occurrence, object deformation, object fracture, task success, task failure, actuator saturation, user intervention, fallback activation, release-authorization revocation, or violation of a validator-derived grip envelope. Updates may be applied locally, transmitted to a host robot, aggregated at a fleet-level edge server, or used by a remote data enter training system to produce updated tactile models, grip policies, object models, calibration adjustments, or software updates.

In some embodiments, the tactile prediction model is personalized to the robotic hand module using a hand-specific calibration or wear state profile. The hand-specific profile may include tactile sensor offsets, tactile sensor drift, tendon stretch, cable slack, joint backlash, actuator response curves, motor friction, gear wear, elastomeric skin wear, maximum force envelope, thermal characteristics, cumulative duty cycles, repair history, component replacement history, firmware trust level, or authorized host-robot compatibility. The hand-local predictive tactile validator may adjust model weights, thresholds, confidence scores, or grip-safety policies based on the hand-specific profile.

### E. Computing Environment

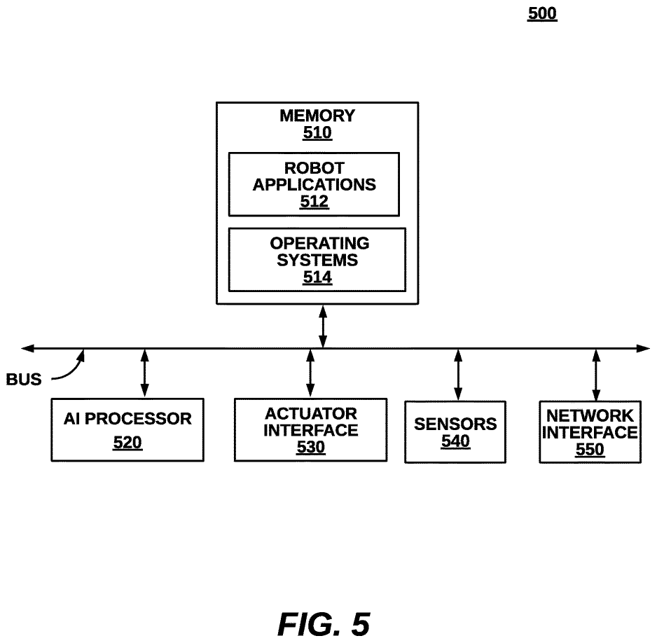

Referring to FIG. 5, a block diagram illustrates an example computing environment 500 for implementing the humanoid robot 100, computer servers, or other devices. The computing environment 500 includes a memory 510, an AI processor 520, an actuator interface 530, sensors 540 and network interface 550. The memory 510 can store network applications 512 and an operating system 520 in long-term and short-term memory devices. Specific implementations have different configurations.

A local hand computing environment may include tactile sensor interfaces, actuator driver interfaces, real-time control loops, a tactile prediction model, a grip release controller, a release authorization generator, and calibration memory. The local hand computing environment may execute deterministic firmware, learned models, safety logic, or hybrid validators.

A robot-level computing environment may include a robot brain, operating system, middleware, perception stack, VLA model, world model, planner, robot-level predictive validator, actuator firewall, and whole-body controller. A fleet-level or facility-level computing environment may include edge servers, local data centers, networked robots, shared state repositories, map servers, semantic hazard repositories, and policy engines. A remote data enter computing environment may include large AI models, simulation clusters, training systems, digital twin infrastructure, policy refinement services, and model distribution systems.

The local hand module may communicate with the host robot through a wired or wireless interface, such as EtherCAT, CAN, CAN-FD, CAN-XL, Ethernet, USB, PCIe, serial bus, safety bus, robotic middleware bus, proprietary interface, or wireless communication channel. In some embodiments, the local hand module continues validating and enforcing safe actuation when disconnected from fleet-level or remote data center services.

The disclosed techniques may be implemented as executable instructions stored on a non-transitory computer-readable medium. In other embodiments, portions of the disclosed techniques may be implemented in firmware, programmable logic, hardware state machines, secure hardware, safety-rated controllers, or combinations thereof.

### II. METHODS FOR HAND-LOCAL PREDICTIVE VALIDATION

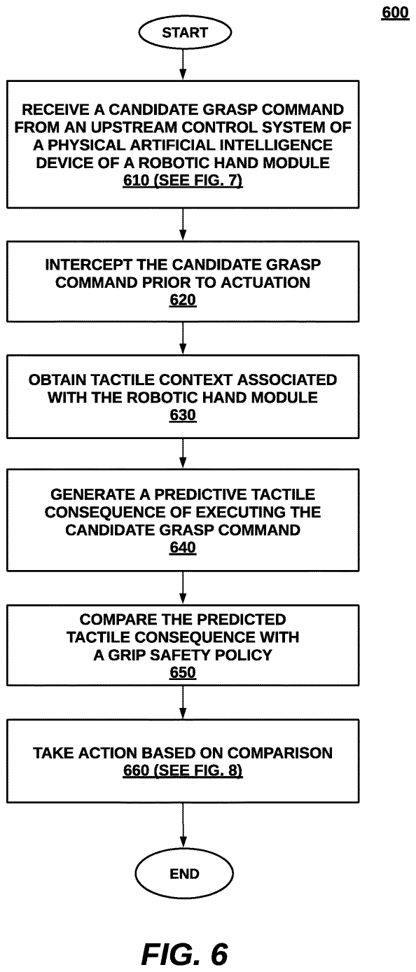

Referring to FIG. 6, a flow chart illustrates a method 600 for hand-local predictive tactile validation, according to an embodiment.

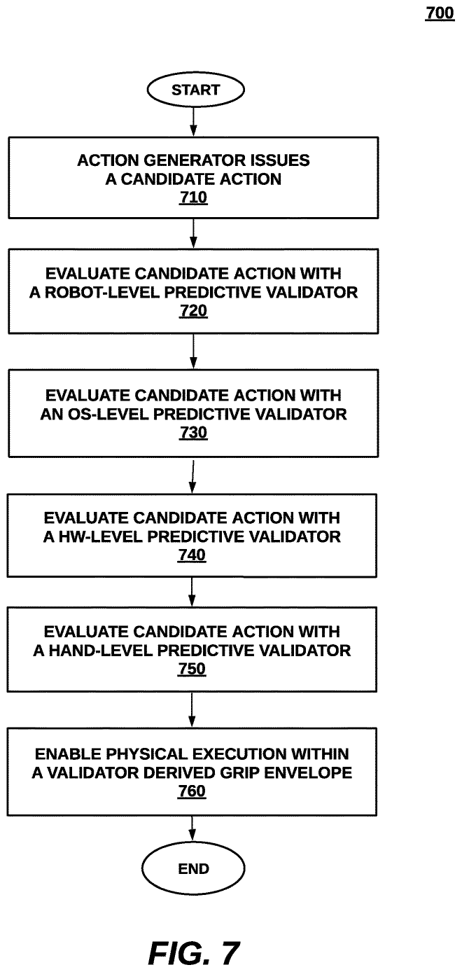

At step 610, a robotic hand module receives a candidate grasp command from an upstream control system, as discussed in more detail with respect to FIG. 7. The upstream control system may be part of a centralized humanoid robot architecture or may be a host system to which a vendor-agnostic modular hand is attached.

At step 620, the robotic hand module intercepts the candidate grasp command at a hand command interface before a corresponding actuator command is transmitted to a finger actuator.

At step 630, the hand-local predictive tactile validator obtains tactile context associated with the robotic hand module. The tactile context may include current tactile sensor data, contact history, actuator state, object descriptors, surface descriptors, calibration data, wear state data, tendon state, or other hand-specific data.

At step 640, the hand-local predictive tactile validator generates a predicted tactile consequence of executing the candidate grasp command.

At step 650, the grip release controller compares the predicted tactile consequence with a grip safety policy.

At step 660, based on the comparison, the grip release controller takes action, such as releases, modifies, delays, decomposes, or blocks the candidate grasp command before corresponding finger actuation.

In some embodiments, modifying the candidate grasp command includes reducing a grip force, changing a contact point, changing a finger trajectory, altering digit sequencing, changing stiffness, reducing actuator velocity, reducing actuator current, changing wrist pose, changing active palm motion, or selecting a different grasp type.

In some embodiments, decomposing the candidate grasp command includes generating staged subcommands. A grasp may be decomposed into approach, light contact, tactile sampling, partial closure, stability confirmation, final closure, lift, tool alignment, insertion, or release. Each subcommand may be validated before actuator release.

Referring to FIG. 7, a flow chart illustrates a method 700 for layered validation, according to an embodiment.

At step 710, a physical AI action generator generates a candidate action. The candidate action may include a reach-and-grasp action, tool use action, insertion action, handover action, shared-load manipulation action, or other physical action.

At step 720, a robot-level predictive actuation validator evaluates the candidate action at a whole-robot level. The robot-level validator may evaluate balance, collision risk, workspace constraints, shared occupancy, load sharing, human proximity, arm kinematics, or macro tactile effects.

At step 730, an operating system-level or middleware-level actuator firewall intercepts an actuator directed request associated with the candidate action. The actuator firewall may normalize the request into a candidate action object, obtain context, select validators, and determine whether the request satisfies actuation policies. If the candidate action includes grasping or dexterous manipulation, the actuator firewall, robot operating system, or host controller routes the grasp related portion of the candidate action to the robotic hand module.

At step 740, the hand local predictive tactile validator performs localized tactile validation focused on finger actuation and hand object contact mechanics.

At step 750, if the hand local validator approves or modifies the command, a release authorization or validated actuator command is generated.

At step 760, a hardware enforced actuator controller enables physical execution only within a validator derived grip envelope.

In some embodiments, telemetry is captured and provided to one or more of the hand local validator, robot-level validator, actuator firewall, fleet-level inference system, or remote data enter training system.

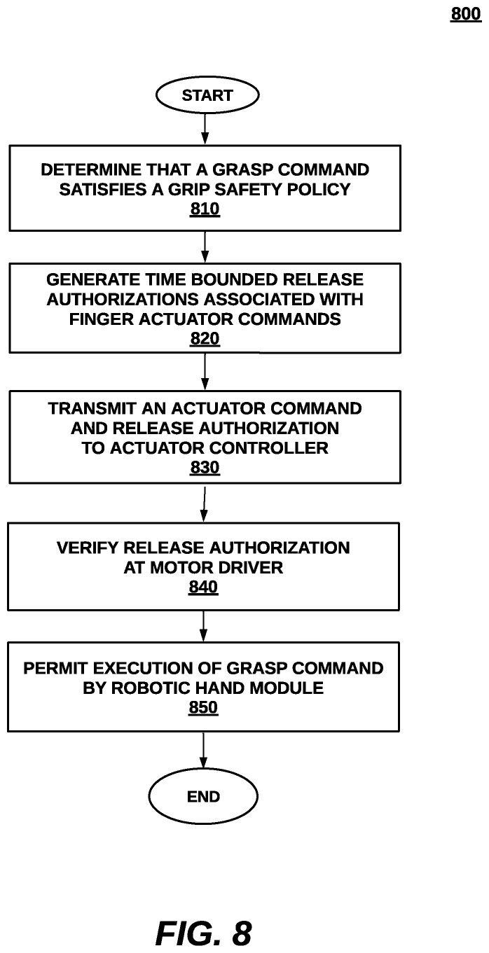

Referring to FIG. 8, a flow chart illustrates a method 800 for release authorization enforcement, according to an embodiment.

At step 810, a grip release controller determines that a grasp command or subcommand satisfies a grip safety policy.

At step 820, the grip release controller generates one or more time bounded release authorizations associated with one or more finger actuator commands.

At step 830, the finger actuator interface transmits an actuator command and corresponding release authorization to a motor driver or actuator controller.

At step 840, the motor driver or actuator controller verifies the release authorization. Responsive to successful verification, the motor driver permits execution within a validator-derived grip envelope, at step 850.

Alternatively, responsive to authorization expiration, revocation, mismatch, failed authentication, envelope violation, or unsafe actuator telemetry, the motor driver rejects the command, clips the command, enters a fallback hold state, terminates the actuation, or requests reauthorization.

In some embodiments, the hand module updates prediction models based on downstream outcomes. Such outcomes may include actual tactile responses, slip occurrence, object deformation, object fracture, task success, task failure, actuator saturation, intervention, fallback activation, or envelope violation. Updates may occur locally, at a robot brain, at a fleet edge server, or at a remote data center.

### III. GENERALITIES

The techniques described herein may be implemented in hardware, firmware, software, or any combination thereof. A hand local validator may be implemented as an embedded processor, microcontroller, ASIC, FPGA, neural processing unit, secure enclave, firmware routine, software module, or distributed hardware and software subsystem.

Although many examples refer to humanoid robotic hands, the same techniques may be applied to robot grippers, industrial end effectors, prosthetic hands, surgical manipulators, warehouse manipulators, underwater manipulators, aerial drone grippers, construction robots, agricultural robots, medical robots, domestic robots, and other robotic end effectors.

A “candidate grasp command” may include a command to grasp, release, hold, squeeze, lift, rotate, insert, align, push, pull, twist, hand over, catch, stabilize, manipulate, or otherwise physically interact with an object. The command may be low-level, high-level, or intermediate-level.

A “hand local” component need not be located exclusively within a palm. It may be located in a palm, wrist, carpal chassis, forearm housing, finger module, hand controller, actuator controller, or mechanically and electrically associated module configured to validate hand actuation before finger actuator release.

A “tactile consequence” may include any predicted contact-related outcome of a proposed hand action, including mechanical, electrical, thermal, material, stability, safety, or task-related effects. The prediction may be explicit or implicit, model-based or learned, continuous or categorical.

A “host robot” may include a humanoid robot, mobile robot, fixed robot, industrial robot, teleoperated robot, medical robot, warehouse robot, autonomous vehicle, drone, or other physical AI platform configured to receive or attach a robotic hand module. A robotic hand module may be configured for a particular host robot or may be vendor-agnostic across different host robot architectures.

The validation layers described herein may be complementary. A robot-level validator may determine whether a macro-level candidate action should proceed. An operating system-level or middleware-level actuator firewall may mediate actuator-directed requests and enforce policy across heterogeneous actuator endpoints. A hand local validator may determine whether local tactile conditions permit finger actuation. An actuator-level enforcement layer may physically prevent unauthorized actuation. The existence of one layer does not require or exclude the existence of another layer.

The AI models described herein may include neural networks, transformers, vision-language-action models, large language models, small language models, diffusion policies, reinforcement-learning policies, imitation-learning policies, world models, tactile prediction models, physics-informed neural networks, control barrier models, learned dynamics models, digital twins, semantic classifiers, object-compliance models, friction models, or hybrid deterministic and learned models.

The local hand inference layer may be used for low-latency safety decisions. The robot-level inference layer may be used for whole-body reasoning and manipulation planning. The fleet-level or edge inference layer may be used for shared environment and shared object knowledge. The remote data enter inference layer may be used for training, model updates, simulation, large-scale reasoning, or policy refinement. Any inference tier may be omitted, replaced, duplicated, or combined.

The grip release controller may perform release, modification, delay, decomposition, or blocking in a deterministic, probabilistic, rule-based, learning-based, hybrid, or policy-driven manner. In some embodiments, the hand local validator may operate even if a host robot lacks a robot-level predictive validator, lacks an actuator firewall, or lacks remote connectivity.

I claim:

1. A modular robotic hand assembly configured for attachment to a host robot, comprising:
a host-attachment interface configured to couple the modular robotic hand assembly to the host robot;
a hand command interface configured to receive a candidate grasp command from an upstream control system associated with the host robot;
a plurality of articulated digits;
a plurality of tactile sensors positioned to sense contact associated with the plurality of articulated digits;
a plurality of finger actuators configured to move the plurality of articulated digits;
a finger-actuator interface configured to transmit actuator commands to the plurality of finger actuators;
a hand local predictive tactile validator positioned logically between the hand command interface and the finger actuator interface, the hand local predictive tactile validator configured to generate, before transmission of a corresponding actuator command through the finger actuator interface, a predicted tactile consequence of executing the candidate grasp command; and
a grip release controller configured to compare the predicted tactile consequence with a grip-safety policy and, based on the comparison, selectively release, modify, delay, decompose, or block the candidate grasp command before corresponding motion is executed by the plurality of finger actuators.

2. The modular robotic hand assembly of claim 1, wherein the upstream control system comprises at least one of a host robot controller, a robot brain, a robot operating system, an actuator firewall, a whole-body action generator, a vision-language-action model, a grasp planner, a teleoperation controller, a fleet controller, or a remote inference service.

3. The modular robotic hand assembly of claim 1, wherein the modular robotic hand assembly is configured to validate the candidate grasp command independently of whether the host robot includes a robot-level predictive actuation validator.

4. The modular robotic hand assembly of claim 1, wherein the hand command interface comprises a vendor-agnostic command interface configured to receive candidate grasp commands from a plurality of different host robot control architectures.

5. The modular robotic hand assembly of claim 1, wherein the predicted tactile consequence includes at least one of incipient slip, contact-force concentration, object deformation, object fracture likelihood, unstable contact transition, insertion failure, tool-use instability, tendon overload, actuator saturation, finger-linkage collision, wrist torque overload, or loss of grasp stability.

6. The modular robotic hand assembly of claim 1, wherein the hand local predictive tactile validator is configured to generate the predicted tactile consequence based on tactile context including at least one of tactile sensor data, contact history, force-torque data, object descriptor data, surface descriptor data, actuator state data, tendon stretch data, joint-backlash data, hand calibration data, or wear state data.

7. The modular robotic hand assembly of claim 1, wherein modifying the candidate grasp command comprises changing at least one of a grip force, digit trajectory, contact point, finger stiffness, actuator velocity, tendon tension, wrist pose, active palm motion, or grasp sequence.

8. The modular robotic hand assembly of claim 1, wherein decomposing the candidate grasp command comprises generating a plurality of staged subcommands and validating each staged subcommand before transmitting a corresponding actuator command through the finger-actuator interface.

9. The modular robotic hand assembly of claim 1, wherein the grip release controller is configured to generate a time-bounded release authorization for a validated actuator command, and wherein at least one of the plurality of finger actuators, a motor driver, or an actuator controller is configured to reject an actuator command that lacks the time-bounded release authorization.

10. The modular robotic hand assembly of claim 1, further comprising a hand-specific calibration profile stored in nonvolatile memory of the modular robotic hand assembly, wherein the hand local predictive tactile validator modifies the predicted tactile consequence or the grip-safety policy based on the hand-specific calibration profile.

11. A humanoid robot comprising:
a torso;
an arm coupled to the torso;
a robot controller configured to generate a candidate grasp command as part of a candidate physical action;
a robot-level predictive actuation validator configured to evaluate the candidate physical action at a whole-robot level before physical execution; and
a robotic hand assembly coupled to the arm, the robotic hand assembly comprising a hand local predictive tactile validator configured to generate a predicted tactile consequence of executing the candidate grasp command and a grip release controller configured to selectively release, modify, delay, decompose, or block the candidate grasp command before corresponding finger actuation.

12. The humanoid robot of claim 11, further comprising an operating system-level or middleware-level actuator firewall configured to intercept an actuator-directed request associated with the candidate grasp command and route a grasp-related portion of the actuator-directed request to the hand local predictive tactile validator.

13. The humanoid robot of claim 12, wherein the actuator firewall is configured to normalize the actuator-directed request into a candidate-action object and select the hand local predictive tactile validator from among a plurality of validators based on at least one of an action type, actuator identifier, tactile context, human-proximity condition, semantic hazard condition, shared occupancy condition, peer robot state, or shared-load condition.

14. The humanoid robot of claim 11, wherein the robot-level predictive actuation validator evaluates at least one of balance, collision risk, reachability, human proximity, shared occupancy, or cooperative load constraints, and the hand local predictive tactile validator evaluates localized contact mechanics at the robotic hand assembly.

15. The humanoid robot of claim 11, wherein the hand local predictive tactile validator executes on a local processor within the robotic hand assembly, and the robot controller executes at least one larger AI model at a robot brain level.

16. A method for layered validation of a candidate grasp command for a robotic hand, the method comprising:
receiving, at a robotic hand module configured for attachment to a host robot, the candidate grasp command from an upstream control system;
performing, by a first validation layer associated with the host robot, robot-level validation of a candidate physical action associated with the candidate grasp command;
intercepting, by a second validation layer comprising an operating system-level or middleware-level actuator firewall, an actuator-directed request associated with the candidate grasp command;
routing, by the second validation layer, a grasp-related portion of the actuator-directed request to a hand local predictive tactile validator of the robotic hand module;
generating, by the hand local predictive tactile validator based on tactile context associated with the robotic hand module, a predicted tactile consequence of executing the candidate grasp command;
comparing the predicted tactile consequence with a grip-safety policy; and
based on the comparison, selectively releasing, modifying, delaying, decomposing, or blocking the candidate grasp command before corresponding finger actuation.

17. The method of claim 16, wherein the first validation layer evaluates a macro-level physical consequence of the candidate physical action, and the hand local predictive tactile validator evaluates a localized contact-related physical consequence of the candidate grasp command.

18. The method of claim 16, further comprising generating, responsive to determining that the predicted tactile consequence satisfies the grip-safety policy, a release authorization defining a validator-derived grip envelope for at least one finger actuator.

19. The method of claim 18, further comprising maintaining the at least one finger actuator in a non-executable state unless the release authorization is verified, and enabling physical execution by the at least one finger actuator only within the validator-derived grip envelope.

20. The method of claim 16, further comprising executing a local hand inference layer within the robotic hand module and receiving a policy update, object model, tactile prediction model update, or validation parameter from at least one of a robot-level inference layer, a fleet-level inference layer, or a remote data enter inference layer.
